(19) United States
(12) Patent Application Publication
(10) Pub. No.: US 2003/0194547 A1
(43) Pub. Date: Oct. 16, 2003

(54) Membrane composite structure and method of production

(76) Inventors: Louis P. Fuhrmann, Kansas City, MO (US); Tim Trimble, Slater, MO (US); Raj Pillai, Stilwell, KS (US)

Correspondence Address: Blackwell Sanders Peper Martin LLP, 40 Corporate Woods, Suite 1200, 9401 Indian Creek Parkway, Oveland Park, KS, 66210, US

(21) Appl. No.: 10/123,264

(22) Filed: Apr. 15, 2002

(51) Int. Cl. B32B 3/06; B32B 5/02; B32B 5/18; B32B 27/04

(52) U.S. Cl. 428/304.4; 428/306.6; 428/308.4; 442/76; 442/86; 442/88; 442/286; 442/288; 442/290; 156/309.6

(57) ABSTRACT

A composite structure (12) that includes a first layer that includes a membrane (16) having a first melting point and a plurality of structural elements and a second layer that includes a thermoplastic material (32) having a second melting point that is lower than the first melting point, wherein at least a portion of the thermoplastic material (34) is at least one partially melted to flow around at least one structural element of the plurality of structural elements of the membrane (16) prior to resolidification to attach the first layer (16) to the second layer (32). The membrane (16) can be oleophobic or oleophilic and preferably includes expanded polytetrafluoroethylene. The thermoplastic material (32) can be of virtually any type and can be either hydrophobic or hydrophilic.

### FIELD OF THE INVENTION

This invention relates to a composite structure, and more particularly, to an improved composite structure that utilizes a thermoplastic material that is thermally melted to a porous membrane and a method of production.

### BACKGROUND OF THE INVENTION

A membrane, such as an expanded polytetrafluoroethylene (ePTFE) membrane, provides a significant advantage of being porous. This allows perspiration and moisture vapor to pass directly through the membrane while remaining waterproof. A significant drawback to the tremendous potential of this material is that body oils, sweat, suntan lotion, and makeup can contact and “foul” portions of the membrane and create areas that no longer prevent water passage through the membrane and thereby negate the waterproof nature of such a membrane.

The present invention is directed to overcoming the drawback set forth above.

### SUMMARY OF INVENTION

In one aspect of this invention, a composite structure is disclosed. This composite structure includes at least one first layer that includes a membrane having a first melting point and a plurality of structural elements. A second layer includes a thermoplastic material having a second melting point that is lower than the first melting point. At least a portion of the thermoplastic material is at least partially melted to flow around at least one structural element of the plurality of structural elements of the membrane prior to resolidification to attach the first layer to the second layer.

In another aspect of this invention, a process for producing a composite structure is disclosed. This process includes combining at least one first layer that includes a membrane having a first melting point and a plurality of structural elements and at least one second layer that includes a thermoplastic material, which is preferably continuous, having a second melting point that is lower than the first melting point. Heat is applied to at least one of the membrane and the thermoplastic material so that at least a portion of the thermoplastic material is at least partially melted to flow around at least one structural element of the plurality of structural elements of the membrane prior to resolidification to attach the at least one first layer to the at least one second layer.

These are merely two illustrative aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a schematic sectional side view of a laminated fabric that includes a composite structure embodying the present invention;

FIG. 2 is an enlarged schematic plan view of a portion of the composite structure illustrated in FIG. 1 with a view that is approximately located along Line 2-2 in FIG. 1;

FIG. 3 is a schematic side view of a thermal melting apparatus for attaching at least one first layer that includes a membrane having a first melting point and a plurality of structural elements with at least one second layer that includes a thermoplastic material having a second melting point that is lower than the first melting point with a heated roll and a water-cooled, compression roll associated with the present invention so that at least a portion of the thermoplastic material is at least partially melted to flow around at least one structural element of the plurality of structural elements of the membrane prior to resolidification to attach the at least one first layer to the at least one second layer;

FIG. 4 is a schematic side view of a first alternative embodiment of a thermal melting apparatus for combining at least one first layer that includes a membrane having a first melting point and a plurality of structural elements, with at least one second layer that includes a thermoplastic material having a second melting point that is lower than the first melting point with an oven that can be heated by oil, gas, electrical resistance or infrared heat associated with the present invention so that at least a portion of the thermoplastic material is at least partially melted to flow around at least one structural element of the plurality of structural elements of the membrane prior to resolidification to attach the at least one first layer to the at least one second layer; and

FIG. 5 is a schematic side view of a second alternative embodiment of a thermal melting apparatus for combining at least one first layer that includes a membrane having a first melting point and a plurality of structural elements, with at least one second layer that includes a thermoplastic material having a second melting point that is lower than the first melting point with an infrared heater associated with the present invention so that at least a portion of the thermoplastic material is at least partially melted to flow around at least one structural element of the plurality of structural elements of the membrane prior to resolidification to attach the at least one first layer to the at least one second layer.

### DETAILED DESCRIPTION OF THE INVENTION

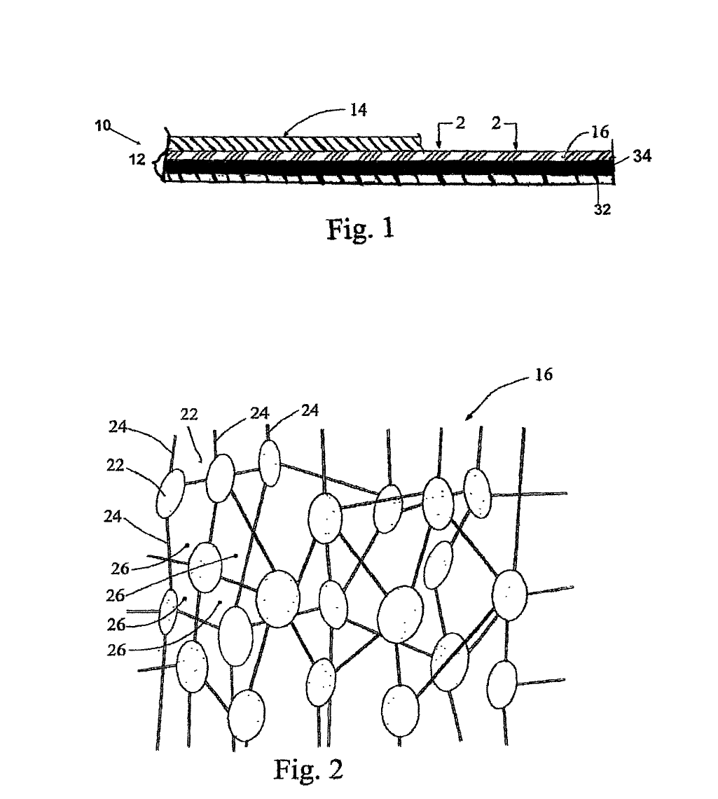

Referring now to FIG. 1, a composite structure, according to the present invention, is generally indicated by numeral 12. This composite structure 12 has a two layer construction and is resistant to wind and moisture while remaining moisture vapor transmissive. Typically, but not necessarily, this composite structure 12 can be combined with a textile material 14 to form a laminated fabric 10 for use in performance apparel, sleeping bags, footwear, industrial fabric applications, and the like. Performance apparel can include, but is not limited to, consumer apparel, workwear, fire service, medical and military applications. This textile material 14 can include virtually any textile fabric base or shell fabric material such as woven textile fabric, knit textile fabric and nonwoven textile fabric so long as the textile material 14 meets the performance and other criteria established for the desired application for the laminated fabric 10. The textile material 14 can be laminated to the composite structure 12 by any suitable process forming an additional third layer to the present invention.

“Moisture vapor transmissive” is defined as being able to readily permit passage of water vapor through the composite structure 12 as well as the entire laminated fabric 10. The composite structure 12 is preferably “oleophobic”, which means that the composite structure 12 is resistant to contamination by absorbing oils, greases or body fluids, such as perspiration and certain contaminating agents. The term “resistant to moisture” is used to described how the composite structure 12 will not “wet” or “wet-out” by a challenge liquid, such as water, and prevents the penetration of liquid through the composite structure 12 under varying ambient conditions of relatively low pressure.

A first layer of the composite structure 12 embodying the present invention includes a membrane and is generally indicated by numeral 16. The membrane 16 is preferably expanded polytetrafluoroethylene (hereinafter also known as “ePTFE”), available under the part number “QM011” from BHA Technologies, Inc., having a place of business at 8800 East 63rd Street, Kansas City, Mo. 64133. However, the membrane 16 may also be made from other suitable materials such as polyolefin, polyamide, polyester, polysufone, polyether, acrylic polymers, methacrylic polymers, polystyrene, polyurethane, polypropylene, polyethylene, cellulosic polymers and combinations thereof. The membrane 16 includes structural elements defining voids, openings, pores or holes, and the like. For example, as shown in FIG. 2, if PTFE is utilized for the membrane 16. The preferred ePTFE material of the membrane 16 is made from a mixture of PTFE fine powder resin and lubricant that is extruded and calendered. These PTFE particles are available under the trademark “TEFLON®” from E. I. du Pont de Nemours and Company, having a place of business at 1007 Market Street, Wilmington, Del. 19898.

This calendered extrudate has the lubricant dried and then is expanded or stretched to create fibrils 24 connecting particles or nodes 22 in a three-dimensional matrix or lattice-type structure with the nodes 22 and fibrils 24 forming the structural elements that define interconnecting pores 26 that extend through the membrane 16. The material is expanded or stretched beyond the elastic limit of the material to introduce permanent set or elongation to the fibrils 24. The size of the pores 26, which are preferably micropores, may be in the range from about 0.01 microns (0.39 microinches) to about 10 microns (393.70 microinches) and are preferably in the range from about 0.3 microns (11.81 microinches) to about 5.0 microns (196.85 microinches). With other types of material utilized for the membrane 16, the structural elements could include cell walls such as that found in urethane and any other structural support located around the voids, openings, pores or holes and the like that are present in the membrane 16. The membrane 16 may be heated to reduce residual stress and may be unsintered, partially sintered or fully sintered. Moreover, this first layer that includes a membrane 16 has a first melting point and can be oleophobic or oleophilic.

The composite structure 12 also has a second layer that includes a thermoplastic material that is preferably, but not necessarily, continuous and is generally indicated by numeral 32. This thermoplastic material 32 is defined as any material that is permanently fusible and has a tendency to soften at higher temperatures. Nonlimiting examples include, but are not limited to, polyurethane, polyethylene, polyester, polyether sulfone and combinations thereof. The thermoplastic material 32 has a second melting point that is at a temperature below the temperature of the first melting point of the membrane 16. Moreover, the thermoplastic material 32 can be either hydrophobic or hydrophilic as well as either free standing or supported with a release paper or a release film.

The membrane 16 has a plurality of structural elements that are attached to the thermoplastic material 32 by applying heat to at least one of the membrane 16 and the thermoplastic material 32. At least a portion of the thermoplastic material 32 is melted so that melted thermoplastic material 34 flows around at least one structural element of the plurality of structural elements of the membrane 16 prior to solidification thereby capturing the at least one structural element of the plurality of structural elements of the membrane 16 to attach the membrane 16 to the thermoplastic material 32. A membrane 16 formed of either ePTFE or PTFE is particularly suited to this process since ePTFE and PTFE can withstand a significant amount of heat.

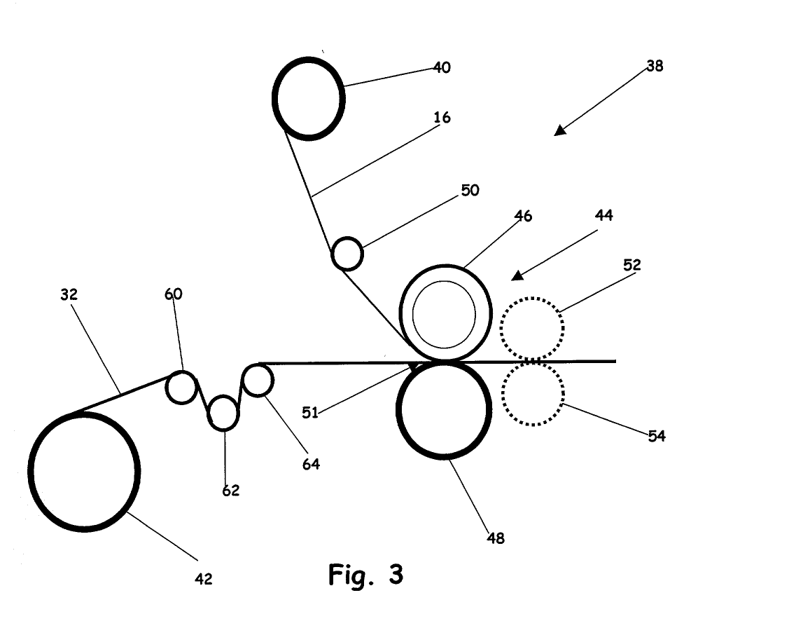

The heating of the membrane 16 to melt the thermoplastic material 32 is preferably accomplished with a melting system, which is generally indicated by numeral 38 in FIG. 3. This melting system 38 includes a hot roll calendering mechanism 44 with a heated roll 46 and a water-cooled, compression roll 48. The water-cooled, compression roll 48 is for applying pressure and is separated from the heated roll 46 by a gap 51.

The vertical position of the lower, water-cooled, compression roll 48 and an upper, heated roll 46 can be reversed. The preferred material for the upper, heated roll 46 includes steel. The pressure and heat applied by the hot roll calendering mechanism 44 between the lower, water-cooled, compression roll 48 and the upper, heated roll 46 as well as the speed of traverse of the composite structure 12 through the lower, water-cooled, compression roll 48 and the upper, heated roll 46 depends on the type and thickness of the membrane 16 and the type and thickness of the thermoplastic material 32. A typical example of these types of hot roll calendering mechanisms 44 can include those manufactured by Webex Inc., having a place of business at 1035 Breezewood Lane, P.O. Box 1026, Neenah, Wis. 54957-1026 as well as Küsters Textile Machinery Corporation, having a place of business at I-85, Zima Park Drive, P.O. Box 6128, Spartanburg, S.C. 29304.

The application of speed, temperature and pressure in combination must generate heat that is below a first melting point for the membrane 16 and above a second melting point for the thermoplastic material 32 in order to create melted thermoplastic material 34 that flows around at least one structural element of the plurality of structural elements of the membrane 16 to capture the at least one structural element to provide attachment when the thermoplastic material 34 again solidifies so that the membrane 16 is attached to the thermoplastic material 32. There is a first roll 40 for the membrane 16, e.g., ePTFE, which preferably, but not necessarily, passes under a first guide roll 50 and then through the hot roll calendering mechanism 44, which includes the lower, water-cooled, compression roll 48 and the upper, heated roll 46. Simultaneously, there is a second roll 42 for the thermoplastic material 32, which preferably, but not necessarily passes over a second guide roll 60, under a third guide roll 62 and over a fourth guide roll 64 and then also goes through the hot roll calendering mechanism 44 in conjunction with the membrane 16. The resultant composite structure 12 leaves the hot roll calendering mechanism 44 and passes through an optional upper nip roll 52 and an optional lower nip roll 54 that are located in opposing relationship. Depending on the application, additional pressure may need to be applied to the composite structure 12 in order to complete the attachment process, as shown in FIG. 1. Only the membrane 16 is heated in this preferred embodiment by the heated roll 46 so that when the heated membrane 16 contacts the thermoplastic material 32, the thermoplastic material 32 is only melted in a localized area 34 that comports with the structural elements found in the membrane 16.

While in the hot roll calendering mechanism 44, the thermoplastic material 32 is applied with sufficient heat and the combination of the membrane 16 and the thermoplastic material 32 is applied with sufficient pressure so that there is at least a partial melting of a portion of the thermoplastic material 32 so that this melted thermoplastic material 34 flows around at least one structural element of the plurality of structural elements of the membrane 16 to capture the at least one structural element to provide attachment when the thermoplastic material 34 again solidifies to form the combined composite structure 12 by attaching the membrane 16 to the thermoplastic material 32.

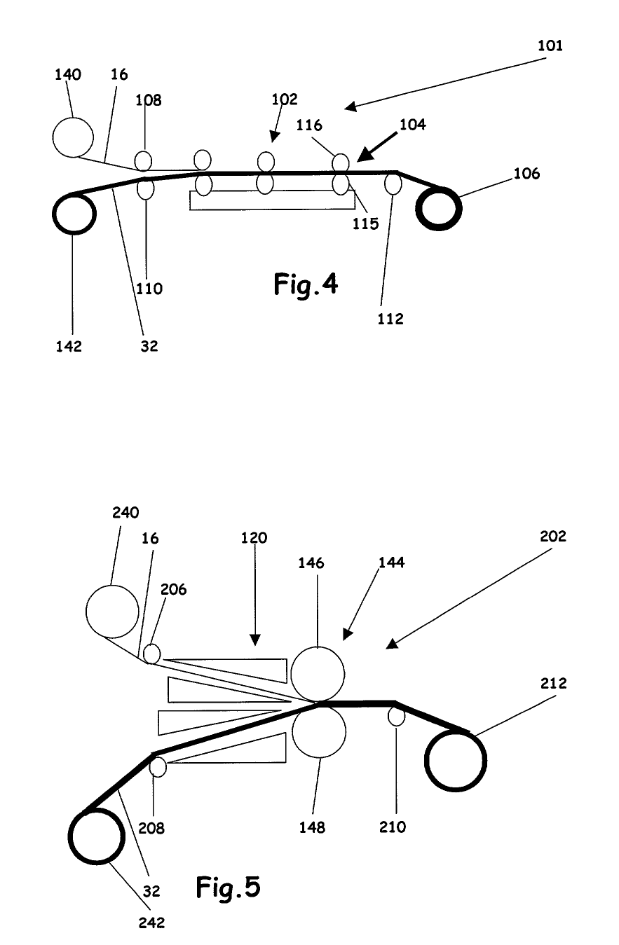

A first alternative embodiment of a melting system is generally indicated by numeral 101 in FIG. 4. This apparatus is for heating the membrane 16 and the thermoplastic material 32 so that melted thermoplastic material 34 flows around at least one structural element of the plurality of structural elements of the membrane 16 prior to resolidification. This melting system 101 utilizes an oven 102. This oven 102 can be heated by virtually any method, including but not limited to, combustion such as that produced by gas or oil, electrical resistance and infrared heat. The pressure and heat applied by the oven 102 as well as the speed of traverse of the composite structure 12 through the oven 102 depends on the type and thickness of the membrane 16 and the type and thickness of the thermoplastic material 32.

A typical example of these types of ovens 102 can include those manufactured by Marshall and Williams Company, having a place of business at 620 South Pleasantburg Drive, PO Box 5285, Greenville, S.C. 29606. The oven 102, may optionally include a calendering mechanism 104 for applying additional pressure, depending on the application, to the composite structure 12 in order to complete the attachment process, as shown in FIG. 1. A typical example of these types of calendering mechanisms 104 can include those manufactured by Webex Inc., having a place of business at 1035 Breezewood Lane, P.O. Box 1026, Neenah, Wis. 54957-1026 as well as Küsters Textile Machinery Corporation, having a place of business at I-85, Zima Park Drive, P.O. Box 6128, Spartanburg, S.C. 29304.

The application of speed, temperature and pressure in combination must generate heat that is below a first melting point for the membrane 16 and above a second melting point for the thermoplastic material 32 in order to create melted thermoplastic material 34 that flows around at least one structural element of the plurality of structural elements of the membrane 16 to capture the at least one structural element to provide attachment when the thermoplastic material 34 again solidifies to attach the first layer 16 to the second layer 32 to form the composite structure 12. There is a first roll 140 for the membrane 16, e.g., ePTFE, which preferably, but not necessarily, passes under a first guide roll 108 and then through the oven 102 and, simultaneously, there is a second roll 142 of the thermoplastic material 32, which preferably, but not necessarily passes over a second guide roll 110 and then also goes through the oven 102 in conjunction with the membrane 16. The resultant composite structure 12 leaves the oven 102 and passes over a third guide roll 112 and then onto a take-up roll 106. Depending on the application, additional pressure may need to be applied to the composite structure 12 from the optional calendering mechanism 104, which includes an upper calender roll 116 and a lower calender roll 115, in order to complete the bonding process, as shown in FIG. 1. The resultant composite structure 12, as it goes through the oven 102, may be supported, unsupported or stretched in a tenter frame. While in the oven 102, the membrane 16 and the thermoplastic material 32 are applied with sufficient heat and pressure so that there is at least a partial melting of a portion of the thermoplastic material 32 so that this melted thermoplastic material 34 flows around at least one structural element of the plurality of structural elements of the membrane 16 to capture the at least one structural element to provide attachment when the thermoplastic material 34 again solidifies to form the combined composite structure 12 by attaching the membrane 16 to the thermoplastic material 32.

A second alternative embodiment of a melting system is generally indicated by numeral 202 in FIG. 4. This apparatus is for heating the membrane 16 and the thermoplastic material 32 so that melted thermoplastic material 34 flows around at least one structural element of the plurality of structural elements of the membrane 16 prior to resolidification. This melting system 202 utilizes an oven 120. The pressure and heat applied by the infrared heater 120 as well as the speed of traverse of the composite structure 12 through the infrared heater 120 depends on the laminated fabric 10, the type and thickness of the membrane 16 and the type and thickness of the thermoplastic material 32.

A typical example of these types of infrared heaters 120 can include those manufactured by IR Systems, having a place of business at 119 Springwater Drive, Jupiter, Fla. 33458. The infrared heater 120, may optionally include a calendering mechanism 144, which includes an upper calender roll 146 and a lower calender roll 148 for applying additional pressure, depending on the application, to the composite structure 12 in order to complete the bonding process, as shown in FIG. 1. A typical example of these types of calendering mechanisms 144 can include those manufactured by Webex Inc., having a place of business at 1035 Breezewood Lane, P.O. Box 1026, Neenah, Wis. 54957-1026 as well as Küsters Textile Machinery Corporation, having a place of business at I-85, Zima Park Drive, P.O. Box 6128, Spartanburg, S.C. 29304.

The application of speed, temperature and pressure in combination must generate heat that is below a first melting point for the membrane 16 and above a second melting point for the thermoplastic material 32 in order to create melted thermoplastic material 34 that flows around at least one structural element of the plurality of structural elements of the membrane 16 to provide attachment when the thermoplastic material 34 again solidifies to attach the membrane 16 to the thermoplastic material 32 to form the composite structure 12.

There is a first roll 240 for the membrane 16, e.g., ePTFE, which preferably, but not necessarily, passes under a first guide roll 206 and then through the infrared heater 120 and, simultaneously, there is a second roll 242 of the thermoplastic material 32, which preferably, but not necessarily passes over a second guide roll 208 and then also goes through the infrared heater 120 in conjunction with the membrane 16 and then the resultant composite structure 12 leaves the infrared heater 120 and passes over a third guide roll 210 and then onto a take-up roll 212. While in the infrared heater 120, the membrane 16 and the thermoplastic material 32 are applied with sufficient heat and pressure so that there is at least a partial melting of a portion of the thermoplastic material 34 so that this melted thermoplastic material 34 flows around at least one structural element of the plurality of structural elements of the membrane 16 to capture the at least one structural element to provide attachment when the thermoplastic material 34 again solidifies to form the combined composite structure 12.

For all embodiments, the composite structure 12 is preferably, but not necessarily, put through standard rewind station for a textile web (not shown) to reverse the position of the membrane 16 and the thermoplastic material 32. This present invention provides a cost-effective alternative to coating or adhesive lamination of the thermoplastic material 32 to the membrane 16. In addition, this present invention significantly broadens the temperature range of performance. For example, the ePTFE material operates as a scaffold that extends the temperature performance range of pure thermoplastic films from −40 degrees Celsius (−40 degrees Fahrenheit) to −6.67 degrees Celsius (+20 degrees Fahrenheit) above the melting temperature of the pure thermoplastic film.

### TEST DESCRIPTIONS

The composite structure 12 is preferably measured for waterproofness by the test method designated ASTM D751, by the American Society for Testing and Materials. The hydrostatic resistance of the composite structure 12, while supported, is measured in accordance with Section 41 of this Test. The level of hydrostatic pressure where failure occurs is much higher for the composite structure 12 over that found in any one individual membrane 16, e.g., ePTFE, or thermoplastic material 32. The composite structure 12 offsets for the weaknesses found in either the pure thermoplastic films or the membranes 16, e.g., ePTFE.

The hydrostatic resistance of the laminated fabric 10 that includes a typical textile material 14 is preferably measured under ASTM D751, Section 41, while supported, and after the application of diesel fuel, gasoline, insect repellant, synthetic perspiration and alcohol. The composite structure 12 demonstrates increased hydrostatic resistance over that found in pure thermoplastic materials 32 or the membranes 16, e.g., ePTFE, when exposed to this collection of solvents and organic liquids.

The laminated fabric 10 is preferably tested under a laundering test that includes placing test samples in a test washing machine per the American Association of Textile Chemists and Colorists (“AATCC”) to determine the durability of the laminated fabric 10. After drying, the test piece is tested by wetting with an application of a few drops of isopropyl alcohol to the surfaces of the test piece, which is representative of both the inner and outer surfaces of the folded piece of laminated fabric 10.

The composite structure 12 is preferably measured for water permeability to determine the moisture vapor transmission rate (MVTR) by the test method designated ASTM E96, by the American Society for Testing and Materials. This includes two basic methods, the Desiccant Method and the Water Method, which are provided for the measurement of permeance. These two variations include conditions where one side of the composite structure 12 is wetted and conditions where there is low humidity on one side of the composite structure 12 and high humidity on the other side of the composite structure 12.

The composite structure 12 is preferably measured for weight by the test method designated ASTM-D3776-96, by the American Society for Testing and Materials, for determining the mass per unit area (weight) of the composite structure 12. There are at least three (3) options, which include: measuring a full piece, roll, bolt or cut of the composite structure 12 (Section 7); measuring a full width sample of the composite structure 12 (Section 8); and measuring a small swatch of the composite structure 12 (Section 9).

The composite structure 12 is preferably measured for air permeability to determine airflow by the test method designated ASTM D737-96, by the American Society for Testing and Materials. This is preferably measured by a Frazier Air Permeability Tester or on a Textest FX 3300 Air Permeability Tester. The composite structure 12 exhibits no measurable air permeability (“wind proof”) while providing breathability, which is otherwise defined as the moisture vapor transmission rate (MVTR). Moreover, the composite structure 12 will provide a complete barrier to microorganisms while providing breathability (MVTR). The moisture vapor transmission rate (MTVR) will be higher for the composite structure 12 than that found with the thermoplastic material 32 by itself since the strength provided by the membrane 16, e.g., ePTFE, allows for a thinner layer of the thermoplastic material 32. Therefore, there is an increased moisture vapor transmission rate (MTVR) in the composite structure 12 as the membrane 16, e.g., ePTFE, will typically not restrict or impede the moisture vapor transmission rate (MTVR).

### EXAMPLE 1

Utilizing the previously described melting system 38 that utilizes a hot roll calendering mechanism 44 that includes a heated roll 46 and a water-cooled, compression roll 48, which are separated by the gap 51, for applying heat to the membrane 16 and pressure to the membrane 16 and the thermoplastic material 32 in order to create melted thermoplastic material 34 that flows around at least one structural element, e.g., node or fibril, of the plurality of structural elements, e.g., nodes and fibrils, of the membrane 16 to provide attachment when the thermoplastic material 34 again solidifies by capturing the at least one structural element, e.g., node or fibril, of the plurality of structural elements, e.g., nodes and fibrils, of the membrane to attach the first layer 16 and the second layer 32 together to form the resulting composite structure 12. In this example, the membrane 16 is ePTFE and the thermoplastic material 32 is polyurethane. The illustrative, but nonlimiting, parameters for creating melted thermoplastic material 34 that flows around at least one structural element, e.g., node or fibril, of the plurality of structural elements, e.g., nodes and fibrils, of the membrane to provide attachment when the thermoplastic material 34 again solidifies includes a temperature range for the hot roll calendering mechanism 44 that extends from about 246.11 degrees Celsius (475 degrees Fahrenheit) to about 265.56 degrees Celsius (510 degrees Fahrenheit). The gap 51 between the water-cooled, compression roll 48 and an heated roll 46 is in a range from about −7.62 millimeters (−0.30 inches) to about zero (0) millimeters (zero (0) inches). The amount of pressure applied by the nip, compression roll 48 against the upper, heated roll 46 is from about 4.22 kilograms per square centimeter (60 pounds per square inch) to about 5.98 kilograms per square centimeter (85 pounds per square inch). The line speed of the composite structure 12 is in a range from about 12.7 centimeters per second (25 feet per minute) to about 20.32 centimeters per second (40 feet per minute). This process resulted in a composite structure 12 that passed all of the previously described Tests with the physical properties of being moisture vapor transmissive, oleophobic, and resistant to moisture while overcoming the “fouling” problems present in a pure membrane, e.g., ePTFE membrane.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

1. A composite structure, which comprises:
at least one first layer that includes a membrane having a first melting point and a plurality of structural elements; and
at least one second layer that includes a thermoplastic material having a second melting point that is lower than the first melting point, wherein at least a portion of the thermoplastic material is at least partially melted to flow around at least one structural element of the plurality of structural elements of the membrane prior to resolidification to attach the at least one first layer to the at least one second layer.

2. The composite structure according to claim 1, wherein the plurality of structural elements is selected from the group consisting of a plurality of nodes and fibrils and a plurality of cell walls.

3. The composite structure according to claim 1, wherein the membrane is selected from the group consisting of expanded polytetrafluoroethylene, polyolefin, polyamide, polyester, polysufone, polyether, acrylic polymers, methacrylic polymers, polystyrene, polyurethane, polypropylene, polyethylene, cellulosic polymers and combinations thereof and the thermoplastic material is selected from the group consisting of polyurethane, polyethylene, polyester, polyether sulfone and combinations thereof.

4. The composite structure according to claim 1, wherein the membrane is selected from the group consisting of an oleophobic membrane and an oleophilic membrane and the thermoplastic material is selected from the group consisting of hydrophobic thermoplastic material and hydrophilic thermoplastic material.

5. A composite structure, which comprises:
at least one first layer that includes an expanded polytetrafluoroethylene membrane having a first melting point and a plurality of nodes and fibrils; and
at least one second layer that includes polyurethane having a second melting point that is lower than the first melting point, wherein at least a portion of the polyurethane is at least partially melted to flow around at least one node or fibril of the plurality of nodes and fibrils of the expanded polytetrafluoroethylene membrane prior to resolidification to attach the at least one first layer to the at least one second layer.

6. A laminated fabric, which comprises:
at least one first layer that includes a membrane having a first melting point and a plurality of structural elements;
at least one second layer that includes a thermoplastic material having a second melting point that is lower than the first melting point, wherein at least a portion of the thermoplastic material is at least partially melted to flow around at least one structural element of the plurality of structural elements of the membrane prior to resolidification to attach the at least one first layer to the at least one second layer; and
at least one third layer of textile material that is attached to either the at least one first layer or the at least one second layer.

7. The composite structure according to claim 6, wherein the plurality of structural elements is selected from the group consisting of a plurality of nodes and fibrils and a plurality of cell walls.

8. The laminated fabric according to claim 6, wherein the membrane is selected from the group consisting of expanded polytetrafluoroethylene, polyolefin, polyamide, polyester, polysufone, polyether, acrylic polymers, methacrylic polymers, polystyrene, polyurethane, polypropylene, polyethylene, cellulosic polymers and combinations thereof and the thermoplastic material is selected from the group consisting of polyurethane, polyethylene, polyester, polyether sulfone and combinations thereof.

9. The laminated fabric according to claim 6, wherein the at least one third layer of textile material is selected from the group consisting of woven textile fabric, knit textile fabric and nonwoven textile fabric.

10. A laminated fabric, which comprises:
at least one first layer that includes an expanded polytetrafluoroethylene membrane having a first melting point and a plurality of nodes and fibrils;
at least one second layer that includes polyurethane having a second melting point that is lower than the first melting point, wherein at least a portion of the polyurethane is at least partially melted to flow around at least one node or fibril of the plurality of nodes and fibrils of the expanded polytetrafluoroethylene membrane prior to resolidification to attach the at least one first layer to the at least one second layer; and
at least one third layer of textile material that is attached to either the at least one first layer or the at least one second layer.

11. A process for producing a composite structure comprising:
combining at least one first layer that includes a membrane having a first melting point and a plurality of structural elements with at least one second layer that includes a thermoplastic material having a second melting point that is lower than the first melting point; and
applying heat to at least one of the membrane and the thermoplastic material so that at least a portion of the thermoplastic material is at least partially melted to flow around at least one structural element of the plurality of structural elements of the membrane prior to resolidification to attach the at least one first layer to the at least one second layer.

12. The process for producing a composite structure according to claim 11, wherein the plurality of structural elements is selected from the group consisting of a plurality of nodes and fibrils and a plurality of cell walls.

13. The process for producing a composite structure according to claim 11, wherein the membrane is selected from the group consisting of expanded polytetrafluoroethylene, polyolefin, polyamide, polyester, polysufone, polyether, acrylic polymers, methacrylic polymers, polystyrene, polyurethane, polypropylene, polyethylene, cellulosic polymers and combinations thereof and the thermoplastic material is selected from the group consisting of polyurethane, polyethylene, polyester, polyether sulfone and combinations thereof.

14. The process for producing a composite structure according to claim 11, wherein the applying heat to at least one of the membrane and the thermoplastic material so that at least a portion of the thermoplastic material is at least partially melted to flow around at least one structural element of the plurality of structural elements of the membrane prior to resolidification to attach the at least one first layer to the at least one second layer includes calendering.

15. The process for producing a composite structure according to claim 14, wherein the calendering includes utilizing a heated roll and a cooled roll.

16. The process for producing a composite structure according to claim 11, wherein the applying heat to at least one of the membrane and the thermoplastic material so that at least a portion of the thermoplastic material is at least partially melted to flow around at least one structural element of the plurality of structural elements of the membrane prior to resolidification to attach the at least one first layer to the at least one second layer includes applying infrared heat.

17. The process for producing a composite structure according to claim 11, wherein the applying heat to at least one of the membrane and the thermoplastic material so that at least a portion of the thermoplastic material is at least partially melted to flow around at least one structural element of the plurality of structural elements of the membrane prior to resolidification to attach the at least one first layer to the at least one second layer includes applying heat from an oven.

18. A process for producing a composite structure comprising:
combining at least one first layer that includes an expanded polytetrafluoroethylene membrane having a first melting point and a plurality of nodes and fibrils with at least one second layer that includes polyurethane having a second melting point that is lower than the first melting point; and
applying heat with calendering to at least one of the expanded polytetrafluoroethylene membrane and the polyurethane so that at least a portion of the polyurethane is at least partially melted to flow around at least one node or fibril of the plurality of nodes and fibrils of the expanded polytetrafluoroethylene membrane prior to resolidification to attach the at least one first layer to the at least one second layer.

19. The process for producing a composite structure according to claim 18, wherein the membrane is selected from the group consisting of expanded polytetrafluoroethylene, polyolefin, polyamide, polyester, polysufone, polyether, acrylic polymers, methacrylic polymers, polystyrene, polyurethane, polypropylene, polyethylene, cellulosic polymers and combinations thereof and the thermoplastic material is selected from the group consisting of polyurethane, polyethylene, polyester and combinations thereof.

20. The process for producing a composite structure according to claim 18, wherein the applying heat to at least one of the membrane and the thermoplastic material so that at least a portion of the thermoplastic material is at least partially melted to flow around at least one structural element of the plurality of structural elements of the membrane prior to resolidification to attach the at least one first layer to the at least one second layer is selected from the group consisting of applying calendering, applying heat from an infrared heater, applying heat from an oil oven, applying heat from a gas oven, applying heat from an electrical resistance oven and applying heat from an infrared heater oven.
